(19) United States
(12) Patent Application Publication
(10) Pub. No.: US 2003/0193101 A1
(43) Pub. Date: Oct. 16, 2003

(54) SUPER RESOLUTION OPTICAL DISK MOTHER MOLD

(76) Inventor: BING MAU CHEN, NANTOU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,689

(22) Filed: Feb. 10, 2003

(30) Foreign Application Priority Data
Apr. 11, 2002 (TW) 91107274

(51) Int. Cl. B29D 11/00; C25D 3/12

(52) U.S. Cl. 264/1.36; 264/2.5; 205/271

(57) ABSTRACT

A super resolution optical disk mother mold, having a substrate, a super resolution structure and a patterned photoresist layer. The super resolution is disposed between the substrate and the patterned photoresist layer. The super resolution optical disk mother mold is fabricated on the substrate prior to formation of the photoresist layer. The above process does not cause the problem of pre-exposing the photoresist layer. In addition, the surface roughness caused by thin-film particle will not occur to the optical disk mother mold fabricated by the above process. Therefore, the optical disk stamper made by the optical disk mother mold will not suffer from the problem of the surface roughness.

### CROSS REFERENCE TO RELATED APPLICATIONS

This application claims the priority benefit of Taiwanese application serial no. 91107274, filed on Apr. 11, 2002.

### BACKGROUND OF INVENTION

1. Field of the Invention

The invention relates in general to a super resolution optical disk mother mold, an optical disk stamper, and a fabrication process thereof, and more particularly, to a super resolution optical disk mother mold, an optical disk stamper and the fabrication process thereof that improves the surface roughness of the mother mold and prevents the pre-exposure of the photoresist layer on the mother mold.

2. Related Art of the Invention

To comply with developments in information technology and popularity of multi-media, high recording density and capacity are demanded for the recording media to meet with the current data storage requirement. The read only optical disks with high recording capacity such as optical disk and digital versatile disk (DVD) are important devices for recording media. The recording capacity of the read only optical disk's is determined by the size and density of the marks on the mother mold, while the size of the marks is determined by the laser beam exposure area of the photoresist layer on the mother mold.

FIG. 1 shows a conventional fabrication process of an optical disk mother mold using a laser beam focused on a photoresist layer. Referring to FIG. 1, a substrate 100 is provided. A photoresist layer 102 is formed on the substrate 100. A laser beam 106 is focused on the photoresist layer 102 via an object lens 104, such that the recording area 108 of the photoresist layer 102 is exposed. The dimension of the recording area 108 is limited by the physical diffraction limitation 0.61 λ/NA, where λ is the wavelength of the laser beam, and NA is the numerical aperture. Therefore, to increase the recording density of the mother mold, the laser beam with short wavelength and the object lens with high numerical aperture can be used.

However, the numerical aperture of the currently available object lens is about 0.9. It is very difficult to enhance the recording density by increasing the numerical aperture of the object lens. It is also difficult to reduce the wavelength of the laser beam that has already approached 364 nm. The further reduction of wavelength of the laser beam requires expensive cost outlay. In addition, while using the laser beam with shorter wavelength for exposure, the selected photoresist layer has to match the wavelength of the laser beam. Otherwise, the photosensitivity of the photoresist layer for the laser beam is degraded, and higher resolution cannot be achieved. Accordingly, as enhancement by reducing the wavelength of the laser beam or by increasing the numerical aperture of the object lens is limited, other methods are required to effectively enhance the recording density.

For the dimension of the recording area to breakthrough the optical diffraction limitation, many optical near-field recording methods are proposed. For example, the development of a near-field probe optical recording technique has been developed to obtain the record or read pit with a size of 40 nm to 80 nm. On the other hand, the solid immersion lens (SIL) effectively enhances the equivalent numerical aperture of the object lens, provided that flying head technique is employed, and the work distance between the optical head and the recording material has to be smaller than a half wavelength. This makes the application of such technique to the optical disk mother mold difficult. In addition, methods of using the material super resolution (such as thermal-induced super resolution and surface plasma resolution) to overcome the optical diffraction limitation have also been proposed.

FIG. 2A shows the schematic drawing of fabricating the optical disk mother mold using thermal-induced super resolution. Referring to FIG. 2A, a substrate 200 is provided, and a photoresist layer 202 is formed thereon. A thermal-induced super resolution thin film 208 is formed on the photoresist layer 202. A laser beam 206 is focused on the thermal-induced super resolution thin film 208 via an object lens 204. The temperature of area 210 of the thermal-induced super resolution thin film 208 radiated by the laser beam 206 shows a Gaussian distribution to generate the super resolution effect. Therefore, the dimension of the exposed recording area 212 of the photoresist layer 202 is smaller than the diffraction limit of the laser beam 206.

FIG. 3A shows the conventional process for fabricating the optical disk mother mold using surface plasma super resolution. Referring to FIG. 3A, a substrate is provided, and a photoresist layer 302 is formed thereon. A surface plasma super resolution structure 308 is formed on the photoresist layer 302. The surface plasma super resolution structure 308 includes a dielectric layer 308a, a surface plasma super resolution thin film 308b and a dielectric layer 308c. A laser beam 306 is focused on the surface plasma super resolution structure 308 via an object lens 304. A surface plasma wave with transverse and longitudinal components is generated at the interface between the surface plasma super resolution thin film 308b and the dielectric layer 308c. Via the surface plasma wave (indicated by the arrows), the optical near-field intensity is increased, and the dimension of the recording area 312 of the photoresist layer 302 is smaller than the diffraction limit of the laser beam 306.

It is known from the above that without changing the wavelength of the laser beam 206 and the numerical aperture of the object lens 204, the recording density can be further enhanced by the thermal-induced super resolution and the surface plasma super resolution.

FIG. 3B shows the residual thin-film particle on the photoresist layer of the optical disk mother mold as shown in FIG. 2B. Referring to FIGS. 2B and 3B, development and fixing process is performed on the photoresist layer 202 (303) formed on the substrate 200 (300) after being exposed by the laser beam to form the recording area 212 (312) on the substrate 200 (300). Before the development and fixing process, the thermal-induced super resolution thin film 208 or the thin film of the surface plasma super resolution structure 308 has to be completely removed. However, residual thin-film particles 214 (314) are still remained on the photoresist layer 202 (302) during the removal process. When using such a mother mold to fabricate a stamper, the surface roughness occurs to the stamper.

In addition to the surface roughness issue, as the thermal-induced super resolution thin film 208 or the surface plasma super resolution thin film 308b are fabricated using sputtering process, the photoresist layer 202 (302) is pre-exposed since plasma is produced during the sputtering process. This causes the function failure or poor performance when using the laser beam to write a signal on the photoresist layer 202 (302).

### SUMMARY OF INVENTION

The present invention provides a fabrication process of a super resolution optical disk mother mold that improves the surface roughness of the mother mold and the pre-exposure phenomenon of the photoresist layer on the mother mold.

The present invention further provides a fabrication process for a super resolution optical disk stamper of which the surface roughness is improved.

The present invention also provides a super resolution optical disk mother mold with an even surface. Therefore, a super resolution optical disk stamper with an even surface can be fabricated using the super resolution optical disk mother mold with an even surface.

The fabrication process of the super resolution optical disk mother mold provided by the present invention includes the following steps. A substrate is provided, and a super resolution structure is formed on the substrate. A photoresist layer is formed on the super resolution structure. An object lens and an exposure light source are provided to perform exposure. The exposure light source is incident on the photoresist layer through the super resolution structure to expose a plurality of recording areas of the photoresist layer. The photoresist layer on the recording areas is then removed to achieve the objective of data recording.

In the present invention, the process for fabricating a super resolution optical disk stamper comprises the following steps. A substrate is provided, and a super resolution structure is formed on the substrate. A photoresist layer is formed on the super resolution structure. An object lens and an exposure light source are provided, and the exposure light source is incident from the side of the substrate via the object lens on the photoresist layer, such that a plurality of recording areas of the photoresist layer are exposed. The photoresist layer at the recording areas is removed to form an optical disk mother mold. When the optical disk mother mold is formed, a metal thin film is formed on the optical disk mother mold, and an electroplating layer is formed on the metal thin film.

In the present invention, the super resolution optical disk stamper includes a substrate, a super resolution structure and a patterned photoresist layer, where the super resolution structure is disposed between the substrate and the patterned photoresist layer.

In one embodiment, the super resolution structure includes a thermal-induced super resolution structure, for example. The thermal-induced super resolution structure further comprises a tri-layer structure of a first dielectric layer, a thermal-induced super resolution thin film and a second dielectric layer. The first dielectric layer is formed on the substrate, the thermal-induced resolution thin film is formed on the first dielectric layer, and the second dielectric layer is formed on the thermal-induced super resolution thin film.

The above thermal-induced super resolution structure includes a double layer structure of a first dielectric layer and a thermal-induced super resolution thin film. The first dielectric layer is formed on the substrate, and the thermal-induced super resolution thin film is formed on the first dielectric layer.

The above thermal-induced super resolution structure includes a double layer structure of a thermal-induced super resolution thin film and a second dielectric layer. The thermal-induced super resolution thin film is formed on the substrate, and the second dielectric layer is formed on the thermal-induced super resolution thin film.

The above thermal-induced super resolution structure includes a single layer structure of a thermal-induced super resolution thin film.

The material for forming the thermal-induced super resolution thin film includes silver (Ag), vanadium (V), zinc (Zn), germanium (Ge), indium (In), tellurium (Te), antimony (Sb), gallium (Ga), arsenic (As), tin (Sn) or selenium (Se). The material of the first and second dielectric layer includes silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ), or yttrium oxide (YOₓ).

In the present invention, the super resolution structure includes a surface plasma super resolution structure, for example. The surface plasma super resolution structure includes a tri-layer structure of a first dielectric layer, a surface plasma super resolution thin film and a second dielectric layer. The first dielectric layer is formed on the substrate, the surface plasma super resolution thin film is formed on the first dielectric layer, and the second dielectric layer is formed on the surface plasma super resolution thin film.

The material of the above surface plasma super resolution thin film includes oxide of Ag, V, Pt or Zinc, or metal of Ga, Ge, As, Se, In, Sn, Sb or Te. The material of the first and second dielectric layers includes SiO₂, SiNₓ, ZnS—SiO₂, AlNₓ, SiC, GeNₓ, TiNₓ, TaOₓ or YOₓ.

### BRIEF DESCRIPTION OF DRAWINGS

These, as well as other features of the present invention, will become more apparent upon reference to the drawings wherein:

FIG. 1 shows the process of the conventional optical disk mother mold using a laser beam focused on the photoresist layer directly;

FIG. 2A shows the process of fabricating an optical disk mother mold using the thermal-induced super resolution process;

FIGS. 2B and 3B show the residual thin-film particles remained on the photoresist layer of the conventional mother mold;

FIG. 3A show the process of fabricating an optical disk mother mold using the surface plasma super resolution process;

FIGS. 4A to 4D show the process of using a thermal-induced super resolution process for fabricating a optical disk mother mold in a first embodiment of the present invention;

FIG. 5 shows the structure of the optical disk mother mold using the thermal-induced process in the first embodiment of the present invention;

FIGS. 6 and 7 show the process for fabricating a stamper using the optical disk mother mold fabricated by the thermal-induced super resolution process in the first embodiment;

FIG. 8 shows a process for fabricating a optical disk mother mold using a surface plasma super resolution process in a second embodiment of the present invention;

FIG. 9 shows structure of the optical disk mother mold using the surface plasma process in the second embodiment of the present invention; and

FIGS. 10 and 11 show the process for fabricating a stamper using the optical disk mother mold fabricated by the surface plasma super resolution process in the first embodiment.

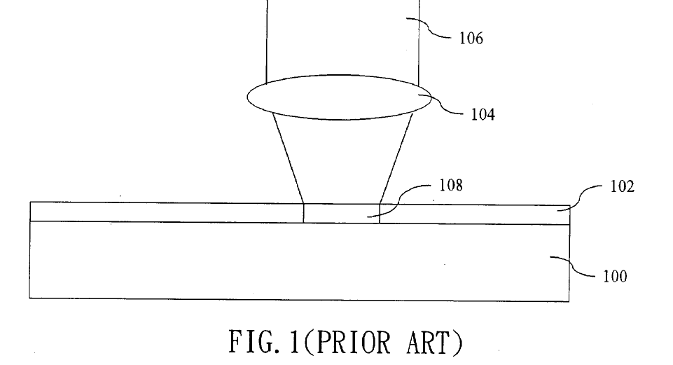

### DETAILED DESCRIPTION

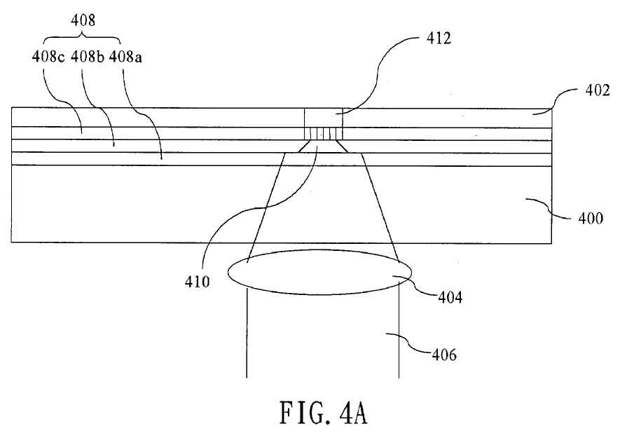

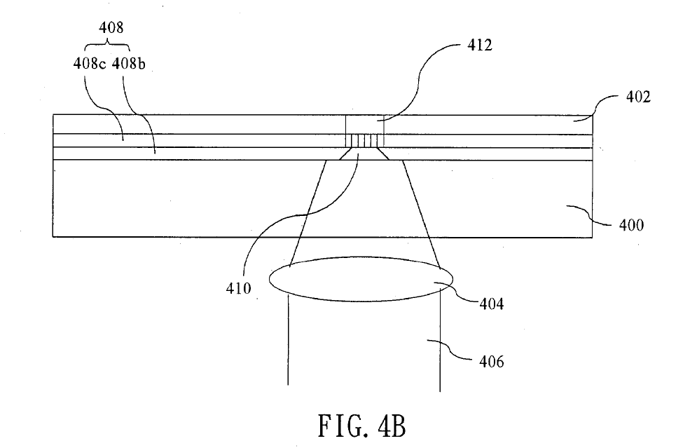

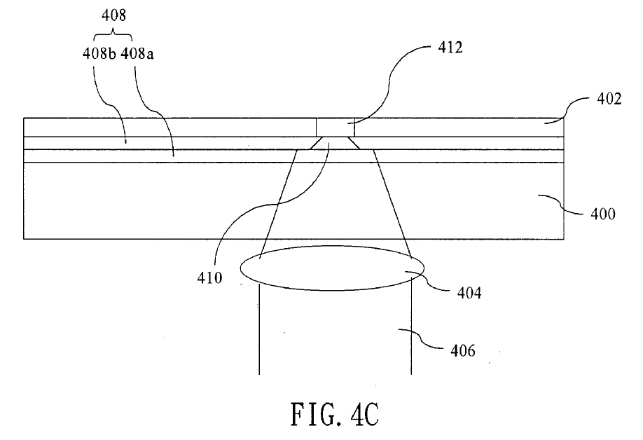

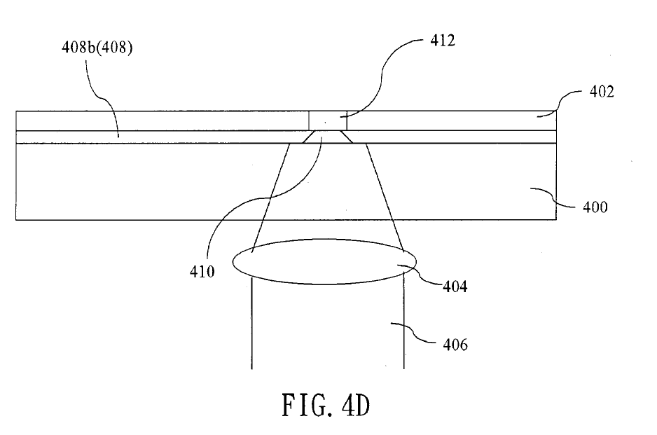

In FIGS. 4A to 4D, a optical disk mother mold fabricated by using a thermal-induced resolution process is shown. Referring to FIG. 4A, a substrate 400 such as a glass substrate or other transparent substrate with good light transmission, proper hardness and nondeforming property is provided. The thickness of the substrate 400 is about 0.2 mm to about 1.2 mm, for example. A thermal-induced super resolution thin film 408 is formed on the substrate 400. The thermal-induced super resolution thin film includes a first dielectric layer 408a, a thermal-induced super resolution thin film 408b and a second dielectric layer 408c, for example. The first dielectric layer 408a is formed on the substrate 400, the thermal-induced super resolution thin film 408b is formed on the first dielectric layer 408a, and the second dielectric layer 408c is formed on the thermal-induced super resolution thin film 408b.

The material for forming the thermal-induced super resolution thin film 408b includes silver (Ag), vanadium (V), zinc (Zn), germanium (Ge), indium (In), tellurium (Te), antimony (Sb), gallium (Ga), arsenic (As), tin (Sn) or selenium (Se), for example. The material of the first and second dielectric layer 408a and 408c includes silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ), or yttrium oxide (YOₓ).

After forming the thermal-induced super resolution structure 408, a photoresist layer 402 is formed on the thermal-induced super resolution structure 408. The method for forming the photoresist layer 402 includes spin coating, for example. In this embodiment, the sequence for forming the thermal-induced super resolution structure 408 and the photoresist layer 402 is opposite to that of prior art. That is, the photoresist layer 402 is formed after the thermal-induced super resolution structure 408 is formed. Therefore, the photoresist layer 402 is not affected during the sputtering process for forming the thermal-induced super resolution thin film 408b to effectively prevent the photoresist layer 402 from being pre-exposed.

After forming the photoresist layer 402, an object lens 404 and an exposure light source 406 are provided. The exposure light source 406 is incident on the photoresist layer 402 from the side of the substrate 400 via the object lens 404. In other words, the exposure light source 406 travels through the thermal-induced super resolution structure 408 to radiate on the photoresist layer 402 to expose the photoresist layer 402 at the recording areas 412.

Being radiated by the exposure light source 406, the temperature of the radiated areas 410 of the thermal-induced super resolution thin film 408b shows a Gaussian distribution. That is, the central part of the radiated areas 410 has a higher temperature, while temperature of the edge of the radiated areas 410 is relatively lower. The exposure light source 406 is not allowed to travel through the edge of the radiated areas 410 with a lower temperature. Therefore, the dimension of the recording areas 412 of the photoresist layer 402 is smaller than the diffraction limit of the exposure light source 406. This is the so-called super resolution effect.

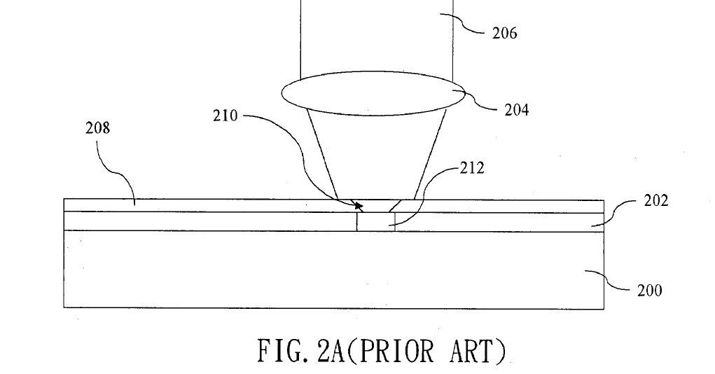

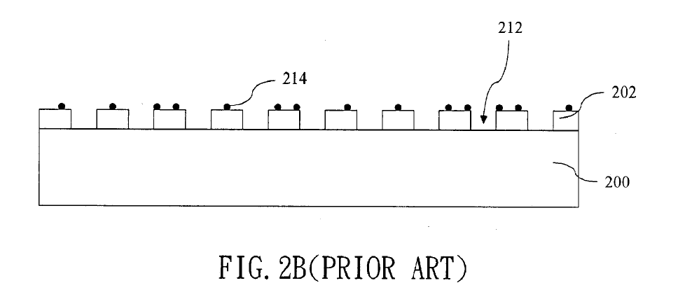

After the exposure, the development and fixing process is performed on the photoresist layer 402 to remove the photoresist layer 402 at the recording areas 412 to complete formation of the optical disk mother mold. In this embodiment, the thermal-induced super resolution structure 408 stays between the substrate 400 and the photoresist layer 402 when the optical disk mother mold is formed. The removal of the thermal-induced super resolution structure 408 is not required, such that the problem of surface roughness of the photoresist layer 202 (FIG. 2B) caused by incomplete removal thereof is resolved.

In addition to the tri-layer structure of the first dielectric layer 408a, the thermal-induced super resolution thin film 408b and the second dielectric layer 408c as shown in FIG. 4A, the thermal-induced super resolution thin film 408b may include a double-layer structure of the thermal-induced super resolution thin film 408b and the second dielectric layer 408c or the double-layer structure of the first dielectric layer 408a (FIG. 4B) and the thermal-induced super resolution thin film 408b (FIG. 4C). Alternatively, the thermal-induced super resolution structure 408 may comprise a single layer structure of the thermal-induced super resolution thin film 408b.

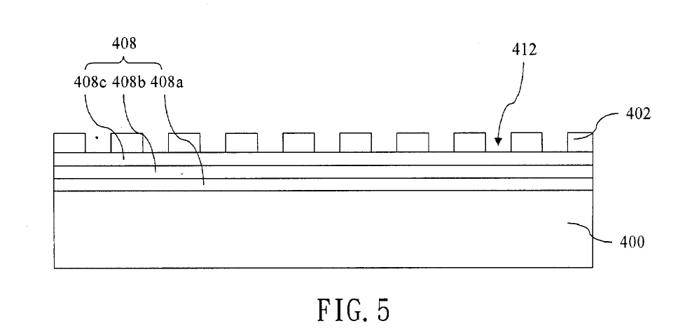

FIG. 5 shows the schematic structure of the optical disk mother mold fabricated by the thermal-induced super resolution process in the first embodiment. Referring to FIG. 5, the optical disk mother mold includes the substrate 400, the thermal-induced super resolution structure 408 and the patterned photoresist layer 402. With respect to FIG. 4A, the thermal-induced super resolution structure 408 comprising the first dielectric layer 408a, the thermal-induced super resolution thin film 408b and the second dielectric layer 408c is disposed between the substrate 400 and the patterned photoresist layer 402. The recording areas 412 are formed after performing exposure, development and fixation on the photoresist layer 402, and the dimension of the recording areas 412 directly affect the recording capacity of the optical disk mother mold.

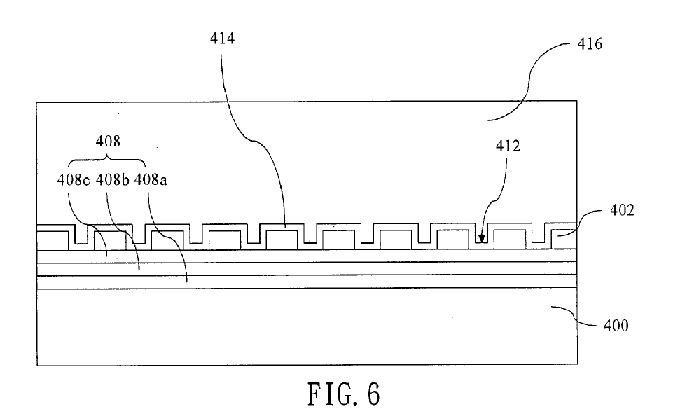

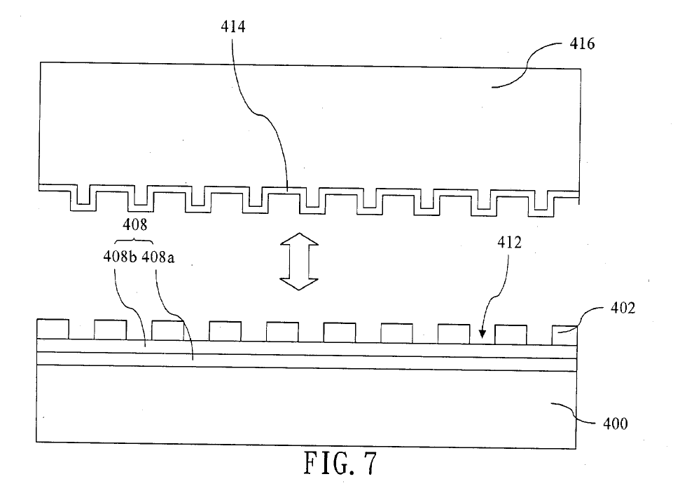

FIGS. 6 and 7 show the optical disk stamper fabricated using the optical disk mother mold formed by the thermal-induced super resolution process. Referring to FIG. 6, a metal thin film 414 is formed on the optical disk mother mold after the optical disk mother mold is fabricated. The metal thin film 414 is conformal to the photoresist layer 402 on the optical disk mother mold, for example. An electroplating layer 416 is formed on the metal thin film 414. The material of the electroplating layer 416 includes nickel, for example.

Referring to FIG. 7, the optical disk stamper made of metal thin film 414 and the electroplating layer 416 is then peeled from the optical disk mother mold. The optical disk stamper can then be used to duplicate blank optical disks by an injection molding machine.

Second Embodiment

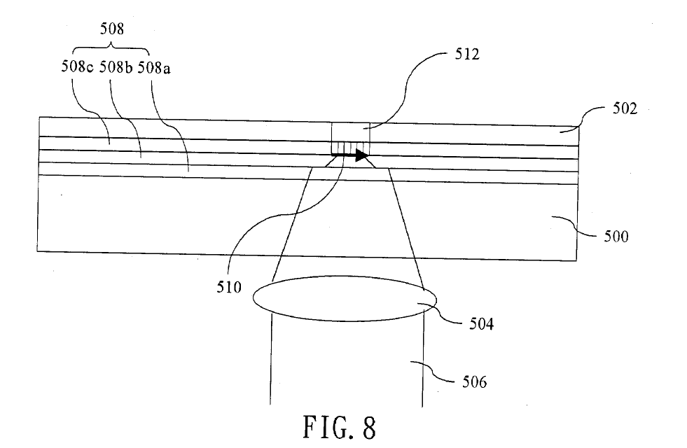

FIG. 8 shows an optical disk mother mold fabricated by using a surface plasma resolution process. Referring to FIG. 8, a substrate 500 such as a glass substrate or other transparent substrate with good light transmission, proper hardness and nondeforming property is provided. The thickness of the substrate 500 is about 0.2 mm to about 1.2 mm, for example. A surface plasma super resolution thin film 508 is formed on the substrate 500. The surface plasma super resolution thin film includes a first dielectric layer 508a, a surface plasma super resolution thin film 508b and a second dielectric layer 508c, for example. The first dielectric layer 508a is formed on the substrate 500, the surface plasma super resolution thin film 508b is formed on the first dielectric layer 508a, and the second dielectric layer 508c is formed on the surface plasma super resolution thin film 508b.

The material for forming the surface plasma super resolution thin film 508b includes oxide of silver (Ag), vanadium (V), zinc (Zn), or platinum (Pt), or metal of gallium (Ga), germanium (Ge), arsenic (As), selenium (Se), indium (In), tin (Sn), antimony (Sb) or tellurium (Te), for example. The material of the first and second dielectric layer 508a and 508c includes silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ), or yttrium oxide (YOₓ). The method for forming the surface plasma super resolution thin film 508b includes sputtering, for example.

After forming the surface plasma super resolution structure 508, a photoresist layer 502 is formed on the surface plasma super resolution structure 508. The method for forming the photoresist layer 502 includes spin coating, for example. In this embodiment, the sequence for forming the surface plasma super resolution structure 508 and the photoresist layer 502 is opposite to that of prior art. That is, the photoresist layer 502 is formed after the surface plasma super resolution structure 508 is formed. Therefore, the photoresist layer 502 is not affected during the sputtering process for forming the surface plasma super resolution thin film 508b to effectively prevent the photosresist layer 502 from being pre-exposed.

After forming the photoresist layer 502, an object lens 504 and an exposure light source 506 are provided. The exposure light source 506 is incident on the photoresist layer 502 from the side of the substrate 500 via the object lens 504. In other words, the exposure light source 506 travels through the thermal-induced super resolution structure 508 to radiate on the photoresist layer 502 to expose the photoresist layer 502 at the recording areas 512.

Being radiated by the exposure light source 506, a surface plasma wave (indicated by the arrows) comprising transverse and longitudinal components is generated at the interface between the surface plasma super resolution thin film 508b and the dielectric layer 508c. By the surface plasma wave 510, the-effect of an enhanced near-field is obtained. Therefore, the dimension of the recording areas 512 of the photoresist layer 502 is smaller than the diffraction limit of the exposure light source 506. This is the so-called super resolution effect.

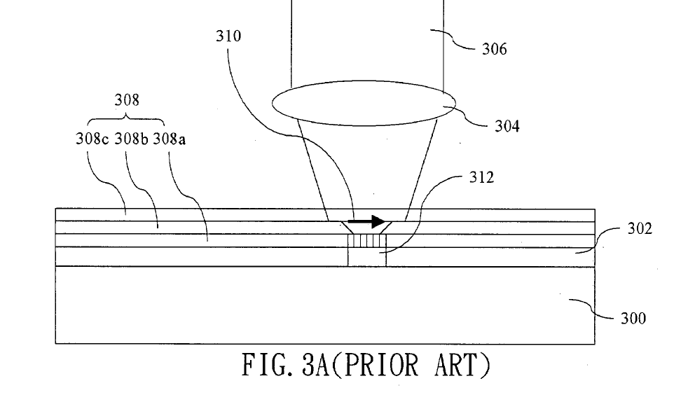

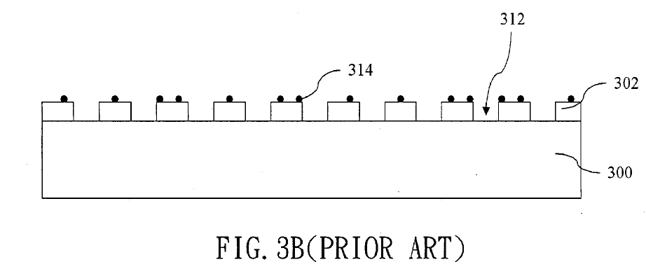

After the exposure, the development and fixing process is performed on the photoresist layer 502 to remove the photoresist layer 502 at the recording areas 512 to complete formation of the optical disk mother mold. In this embodiment, the surface plasma super resolution structure 508 stays between the substrate 500 and the photoresist layer 502 when the optical disk mother mold is formed. The removal of the surface plasma super resolution structure 508 is not required, such that the problem of surface roughness of the photoresist layer 302 (FIG. 3B) caused by incomplete removal thereof is resolved.

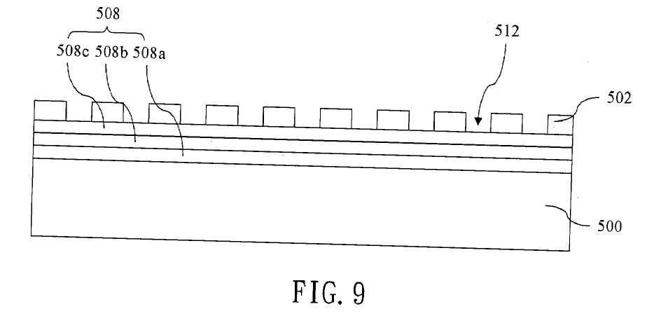

FIG. 9 shows the schematic structure of the optical disk mother mold fabricated by the surface plasma super resolution process in the second embodiment. Referring to FIG. 9, the optical disk mother mold includes the substrate 500, the surface plasma super resolution structure 508 and the patterned photoresist layer 502. The surface plasma super resolution structure 508 comprising the first dielectric layer 508a, the surface plasma super resolution thin film 508b and the second dielectric layer 508c is disposed between the substrate 500 and the patterned photoresist layer 502. The recording areas 512 are formed after performing exposure, development and fixation on the photoresist layer 502, and the dimension of the recording areas 512 directly affect the recording capacity of the optical disk mother mold.

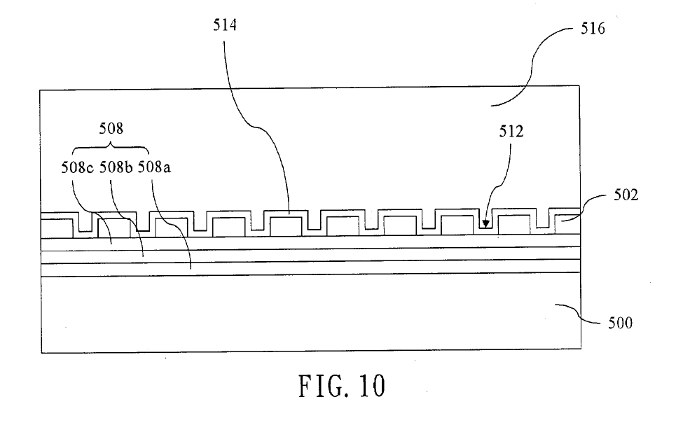

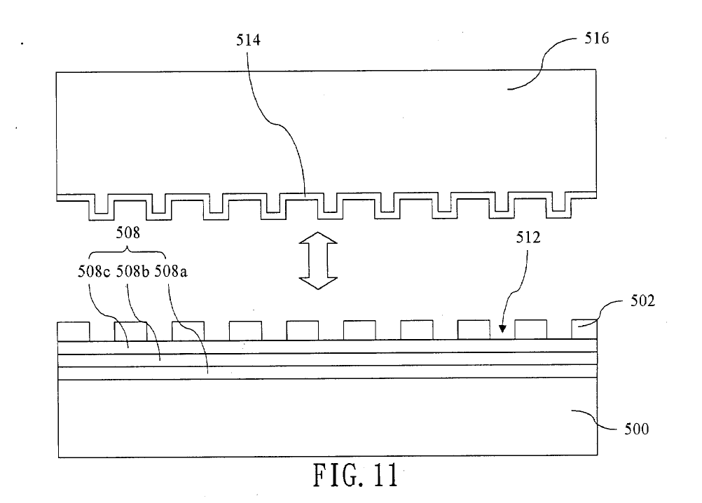

FIGS. 10 and 11 show the optical disk stamper fabricated using the optical disk mother mold formed by the surface plasma super resolution process. Referring to FIG. 10, a metal thin film 514 is formed on the optical disk mother mold after the optical disk mother mold is fabricated. The metal thin film 514 is conformal to the photoresist layer 502 on the optical disk mother mold, for example. An electroplating layer 516 is formed on the metal thin film 514. The material of the electroplating layer 516 includes nickel, for example

Referring to FIG. 11, the optical disk stamper made of the metal thin film 514 and the electroplating layer 516 is then peeled from the optical disk mother mold. The optical disk stamper can then be used to duplicate blank optical disks by an injection molding machine.

According to the above, the super resolution optical disk mother mold, the optical disk stamper and the fabrication process thereof provided by the present invention have at least the following advantages.

1. In the super resolution optical disk mother mold, the photoresist layer has an even surface without being affected by the thin-film particles caused by incomplete removal of the thin film. In addition, the optical disk stamper fabricated by the optical disk mother mold is also prevented from suffering the surface roughness.

2. In the process for fabricating the super resolution optical disk mother mold and optical disk stamper, the thermal-induced or surface plasma super resolution structure is not removed, such that a process step is saved.

3. The problem of pre-exposure of the photoresist layer is not caused in the process for fabricating the super resolution optical disk mother mold and the optical disk stamper.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

1. A process for fabricating a super resolution optical disk mother mold, comprising:
providing a substrate;
forming a super resolution structure on the substrate;
forming a photoresist layer on the super resolution structure;
providing an object lens;
providing an exposure light source incident on the photoresist layer from a side of the substrate to perform exposure, wherein the exposure light source travels through the super resolution structure to radiate the photoresist layer, such that a plurality of recording areas of the photoresist layer are exposed; and
removing the photoresist layer at the recording areas.

2. The process according to claim 1, wherein the step of forming the super resolution structure includes forming a thermal-induced super resolution thin film on the substrate.

3. The process according to claim 2, further comprising forming the thermal-induced super resolution thin film with the material of silver (Ag), vanadium (V), zinc (Zn), germanium (Ge), indium (In), tellurium (Te), antimony (Sb), gallium (Ga), arsenic (As), tin (Sb) or Selenium (Se).

4. The process according to claim 2, further comprising forming a first dielectric layer on the substrate before forming the thermal-induced super resolution thin film.

5. The process according to claim 4, further comprising forming the first dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

6. The process according to claim 2, further comprising forming a second dielectric layer on the substrate after forming the thermal-induced super resolution thin-film.

7. The process according to claim 6, further comprising forming the second dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

8. The process according to claim 1, wherein the step of forming The superresolution structure further comprises:
forming a first dielectric layer on the substrate;
forming a surface plasma super resolution on the first dielectric layer; and
forming a second dielectric layer on the surface plasma super resolution layer.

9. The process according to claim 8, further comprising forming the first dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

10. The process according to claim 8, further comprising forming the second dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

11. The process according to claim 8, further comprising forming the surface plasma super resolution thin film with the material of oxide of silver (Ag), vanadium (V), platinum (Pt), or zinc (Zn), or metal of gallium (Ga), germanium (Ge), arsenic (As), selenium (Se), indium (In), tin (Sn), antimony (Sb) or tellurium (Te).

12. The process according to claim 1, wherein the photoreist layer is a positive photoresist layer.

13. The process according to claim 1, wherein the photoreist layer is a negative photoresist layer.

14. The process according to claim 1, wherein the wavelength of the exposure light source includes 257 nm, 364 nm, 405 nm, 458 nm or 650 nm.

15. A process for forming a optical disk stamper, comprising:
providing a substrate;
forming a super resolution structure on the substrate;
forming a photoresist layer on the super resolution structure;
providing an object lens;
providing an exposure light source incident on the photoresist layer from a side of the substrate to perform exposure, wherein the exposure light source travels through the super resolution structure to radiate the photoresist layer, such that a plurality of recording areas of the photoresist layer are exposed;
removing the photoresist layer at the recording areas to form a optical disk mother mold;
forming a metal thin film on the optical disk mother mold;
forming an electroplating layer on the metal thin film; and
peeling the metal thin film and the electroplating layer from the optical disk mother mold to form the optical disk stamper.

16. The process according to claim 15, wherein the step of forming the super resolution structure includes forming a thermal-induced super resolution thin film on the substrate.

17. The process according to claim 16, further comprising forming the thermal-induced super resolution thin film with the material of silver (Ag), vanadium (V), zinc (Zn), germanium (Ge), indium (In), tellurium (Te), antimony (Sb), gallium (Ga), arsenic (As), tin (Sb) or Selenium (Se).

18. The process according to claim 16, further comprising forming a first dielectric layer on the substrate before forming the thermal-induced super resolution thin film.

19. The process according to claim 18, further comprising forming the first dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ or yttrium oxide (YOₓ).

20. The process according to claim 16, further comprising forming a second dielectric layer on the substrate after forming the thermal-induced super thin film.

21. The process according to claim 20, further comprising forming the second dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

22. The process according to claim 15, wherein the step of forming the super resolution structure further comprises:
forming a first dielectric layer on the substrate;
forming a surface plasma super resolution on the first dielectric layer; and
forming a second dielectric layer on the surface plasma super resolution layer.

23. The process according to claim 22, further comprising forming the first dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

24. The process according to claim 22, further comprising forming the second dielectric layer with the material of silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

25. The process according to claim 22, further comprising forming the surface plasma super resolution thin film with the material of oxide of silver (Ag), vanadium (V), platinum (Pt) or zinc (Zn), or metal of gallium (Ga), germanium (Ge), arsenic (As), selenium (Se), indium (In), tin (Sn), antimony (Sb) or tellurium (Te).

26. The process according to claim 15, wherein the photoresist layer is a positive photoresist layer.

27. The process according to claim 15, wherein the photoresist layer is a negative photoresist layer.

28. The process according to claim 15, wherein the wavelength of the exposure light source includes 257 nm, 364 nm, 405 nm, 458 nm or 650 nm.

29. The process according to claim 15, further comprising forming the electroplating layer with the material of nickel.

30. A super resolution optical disk mother mold, comprising:
a substrate;
a super resolution structure, formed on the substrate; and
a patterned photoresist layer, formed on the super resolution structure.

31. The super resolution optical disk mother mold according to claim 30, wherein the super resolution structure further comprises:
a first dielectric layer, formed on the substrate;
a thermal-induced super resolution thin film, formed on the first dielectric layer; and
a second dielectric layer, formed between the thermal-induced super resolution thin film and the photoresist layer.

32. The super resolution optical disk mother mold according to claim 30, wherein the super resolution structure further comprises:
a thermal-induced super resolution thin film, formed on the first dielectric layer; and
a second dielectric layer, formed between the thermal-induced super resolution thin film and the photoresist layer.

33. The super resolution optical disk mother mold according to claim 30, wherein the super resolution structure further comprises:
a first dielectric layer, formed on the substrate; and
a thermal-induced super resolution thin film, formed on the first dielectric layer.

34. The super resolution optical disk mother mold according to claim 31, claim 32 or claim 33, wherein the material of the first dielectric layer includes silicon oxide (SiO₂), silicon nitride (SiNₓ), zinc sulfide-silicon oxide (ZnS—SiO₂) aluminum nitride (AlNₓ), silicon carbide (SiC), germanium nitride (GeNₓ), titanium nitride (TiNₓ), tantalum oxide (TaOₓ) or yttrium oxide (YOₓ).

35. The super resolution optical disk mother mold according to claim 31, claim 32 or claim 33, wherein the material of the thermal-induced super resolution thin film includes silver (Ag), vanadium (V), zinc (Zn), germanium (Ge), indium (In), tellurium (Te), antimony (Sb), gallium (Ga), arsenic (As), tin (Sn) and selenium (Se).

36. The super resolution optical disk mother mold according to claim 31, claim 32 or claim 33, wherein the material of the second dielectric layer includes silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

37. The super resolution optical disk mother mold according to claim 30, wherein the super resolution structure further comprises:
a first dielectric layer, formed on the substrate;
a surface plasma super resolution thin film, formed on the first dielectric layer; and
a second dielectric layer, formed between the thermal-induced super resolution thin film and the photoresist layer.

38. The super resolution optical disk mother mold according to claim 37, wherein the material of the first dielectric layer includes silicon oxide (SiO₂), silicon nitride (SiNₓ), zinc sulfide-silicon oxide (ZnS—SiO₂), aluminum nitride (AlNₓ), silicon carbide (SiC), germanium nitride (GeNₓ), titanium nitride (TiNₓ), tantalum oxide (TaOₓ) or yttrium oxide (YOₓ).

39. The super resolution optical disk mother mold according to claim 37, wherein the material of the thermal-induced super resolution thin film includes silver (Ag), vanadium (V), zinc (Zn), germanium (Ge), indium (In), tellurium (Te), antimony (Sb), gallium (Ga), arsenic (As), tin (Sn) and selenium (Se).

40. The super resolution optical disk mother mold according to claim 37, wherein the material of the second dielectric layer includes silicon oxide (SiO₂), silicon nitride (SiNₓ), zinc sulfide-silicon oxide (ZnS—SiO₂) aluminum nitride (AlNₓ), silicon carbide (SiC), germanium nitride (GeNₓ), titanium nitride (TiNₓ), tantalum oxide (TaOₓ) or yttrium oxide (YOₓ).
